(19) United States
(12) Patent Application Publication
(10) Pub. No.: US 2026/0290106 A1
(43) Pub. Date: Sep. 24, 2026

(54) COIN HANDLING APPARATUS

(71) Applicant: GLORY LTD., Hyogo (JP)

(72) Inventor: Yoshikatsu OOTA, Hyogo (JP)

(73) Assignee: GLORY LTD., Hyogo (JP)

(21) Appl. No.: 19/570,545

(22) Filed: Mar. 18, 2026

(30) Foreign Application Priority Data
Mar. 19, 2025 (JP) 2025-045364

(51) Int. Cl. G07D 1/02; G07D 9/00; G07D 11/22

(52) U.S. Cl. CPC G07D 1/02; G07D 9/002; G07D 11/22; G07D 2201/00

(57) ABSTRACT

A coin handling apparatus pays out a coin corresponding to a requested number of coins to be paid out based on a dispensing instruction. The coin handling apparatus includes: a multiple denomination storage that stores coins of a plurality of denominations; and a control circuitry that, when it is necessary to pay out a coin of at least one denomination among the plurality of denominations stored in the multiple denomination storage, determines the number of coins to be fed out from the multiple denomination storage based on the requested number and performs a feeding out process of feeding out the coins by the determined number from the multiple denomination storage.

### CROSS REFERENCE TO RELATED APPLICATION

This application is entitled to (or claims) the benefit of Japanese Patent Application No.2025-045364, filed on Mar. 19, 2025, the disclosure of which is incorporated herein by reference in its entirety.

### TECHNICAL FIELD

The technology disclosed herein relates to a coin handling apparatus.

### BACKGROUND ART

In the related art, a coin handling apparatus that can handle a plurality of denominations has been put into practical use. Such a coin handling apparatus comprises a plurality of storage units, and coins of different denominations are stored in the respective storage units. When the dispensing process is performed, the coins of the denominations stored in the respective storage units are fed out in accordance with a requested number of coins to be paid out, so that desired coins are paid out.

Meanwhile, there is a case in which it is necessary to handle a larger number of denominations than the number of storage units provided in the coin handling apparatus. In general, one type of coin is stored in each of the plurality of storage units, but in such a case, coins of a plurality of denominations are stored in at least one of the plurality of storage units.

Here, when the coins are fed out from the storage unit in which the plurality of denominations are stored, it is not clear at which timing the coins of a denomination that are desired to be paid out are fed out. Therefore, it is necessary to feed out a large number of coins from the storage unit that stores coins of a plurality of denominations with respect to the desired number of coins to be paid out.

### SUMMARY

The technology disclosed herein relates to a coin handling apparatus. The coin handling apparatus pays out a coin corresponding to a requested number of coins to be paid out based on a dispensing instruction, the coin handling apparatus including: a multiple denomination storage that stores coins of a plurality of denominations; and a control circuitry that, when it is necessary to pay out a coin of at least one denomination among the plurality of denominations stored in the multiple denomination storage, determines the number of coins to be fed out from the multiple denomination storage based on the requested number and performs a feeding out process of feeding out the coins by the determined number from the multiple denomination storage.

### BRIEF DESCRIPTION OF DRAWINGS

FIG. 1 is a schematic diagram illustrating an example of the configuration of a coin handling apparatus according to the present embodiment;

FIG. 2 is a block diagram illustrating an example of a functional block of the coin handling apparatus;

FIG. 3 is a flowchart illustrating an example of a flow of a dispensing process by the coin handling apparatus according to the present embodiment;

FIG. 4 is a schematic diagram for describing a direct dispensing process; and

FIG. 5 is a schematic diagram for describing a recognition dispensing process.

### DESCRIPTION OF EMBODIMENTS

A coin handling apparatus according to the present disclosure pays out a coin corresponding to a requested number of coins to be paid out based on a dispensing instruction.

The coin handling apparatus may include a multiple denomination storage unit that stores coins of a plurality of denominations.

The coin handling apparatus may further include a control unit that, in a case where it is necessary to pay out coins of at least one denomination among the plurality of denominations stored in the multiple denomination storage unit, determines the number of coins to be fed out from the multiple denomination storage unit based on the requested number and performs a feeding out process of feeding out the coins by the determined number from the multiple denomination storage unit.

The multiple denomination storage unit may store coins in a mixed state and may be capable of counting the number of coins to be fed out, while being incapable of selectively feeding out coins of a specific denomination.

The requested number of coins to be paid out may include the number of coins required for each denomination to be paid out.

The dispensing instruction may include the requested number. The dispensing instruction may include an amount to be paid out, in which case the control unit may determine the requested number based on the amount to be paid out.

The coin handling apparatus may further include a recognition unit. The control unit may identify the denomination of coins fed out from the multiple denomination storage unit by using the recognition unit.

The coin handling apparatus may further include a dispensing unit. The control unit may transport, to the dispensing unit, coins whose denominations match the requested number among the coins fed out from the multiple denomination storage unit, in a quantity corresponding to the requested number.

The control unit may determine the number of coins to be fed out in such a way that all of the requested number of coins to be paid out is fed out from the multiple denomination storage unit with a probability equal to or greater than a predetermined value. The control unit may determine the number of coins to be fed out so that the requested number of coins of the denominations stored in the multiple denomination storage unit among the requested number is fed out from the multiple denomination storage unit.

The number of coins to be fed out is greater than the requested number of coins of the denominations stored in the multiple denomination storage unit. The number of coins to be fed out, Y, may be determined based on the following equation (1). In equation (1), “the instructed number of coins of a maximum instructed denomination” is the number of coins of a denomination having a maximum requested number among the denominations requested by the dispensing instruction with respect to the denominations stored in the multiple denomination storage unit.

$$Y = ( the instructed number of coins of a maximum instructed denomination + 1 ) \times 5 \qquad ( 1 )$$

The coin handling apparatus may further include a memory unit that stores an appropriate quantity of coins for each denomination stored in the multiple denomination storage unit. The appropriate quantity may be a predetermined storage quantity for each denomination, or a coin quantity that causes coins of each denomination stored in the multiple denomination storage unit to have a predetermined ratio.

The control unit may adjust the coin quantity of each denomination in the multiple denomination storage unit based on a difference obtained by comparing the coin quantity of each denomination with the appropriate quantity. Accordingly, the coin quantity of each denomination in the multiple denomination storage unit can be brought closer to the appropriate quantity.

The control unit may control the multiple denomination storage unit so as to pay out coins of a denomination whose coin quantity exceeds the appropriate quantity.

The coin handling apparatus may further include a second multiple denomination storage unit that stores coins of a plurality of denominations.

The control unit may move coins between the multiple denomination storage unit and the second multiple denomination storage unit based on a difference obtained by comparing the coin quantity of each denomination in the multiple denomination storage unit with the appropriate quantity, thereby adjusting the coin quantity of each denomination in the multiple denomination storage unit.

The control unit may perform a transport process of transporting coins of denominations whose coin quantities exceed the appropriate quantity from the multiple denomination storage unit to the second multiple denomination storage unit. The transport process may be performed during a deposit process or a dispensing process.

The control unit may perform a replenishment process of replenishing coins of denominations whose coin quantities are smaller than the appropriate quantity from the second multiple denomination storage unit to the multiple denomination storage unit.

When transporting coins from the multiple denomination storage unit to the second multiple denomination storage unit, the control unit may recognize denominations of the coins fed out from the multiple denomination storage unit by using the recognition unit before transporting the coins to the second multiple denomination storage unit.

The appropriate quantity may be a coin quantity in which a ratio between coin quantities of any two denominations among the plurality of denominations stored in the multiple denomination storage unit falls within a range of 40:60 to 60:40. The coin quantity may be defined as a number of coins. A ratio between two denominations may be defined as a ratio between a number of coins of a first denomination and a number of coins of a second denomination stored in the multiple denomination storage unit.

The control unit may recognize denominations of coins fed out from the multiple denomination storage unit during execution of the feeding out process by the recognition unit.

The coin handling apparatus may further include a single denomination storage unit that stores coins of only one denomination.

In a case where the control unit determines, based on the requested number of coins to be paid out, that coins are to be fed out only from the single denomination storage unit, the control unit may dispense the coins fed out from the single denomination storage unit to the dispensing unit without recognizing denominations of the coins by the recognition unit.

In a case where the control unit determines, based on the requested number of coins to be paid out, that coins are to be fed out from both the single denomination storage unit and the multiple denomination storage unit, the control unit may recognize denominations of the coins fed out from the single denomination storage unit by the recognition unit.

The coin handling apparatus may further include a transport unit that connects the single denomination storage unit, the multiple denomination storage unit, and the recognition unit. At least a part of the coins fed out from the single denomination storage unit and at least a part of the coins fed out from the multiple denomination storage unit may be transported simultaneously by the transport unit.

Hereinafter, an embodiment of the present disclosure will be described in detail with reference to the drawings.

Hereinafter, an embodiment of the present disclosure will be described with reference to the drawings. The present disclosure is not limited to the following embodiment, and can be variously modified without departing from the spirit of the present disclosure. In addition, in the drawings, the same reference numerals indicate the same or corresponding components, which are common throughout the specification.

### Configuration of Coin Handling Apparatus 1

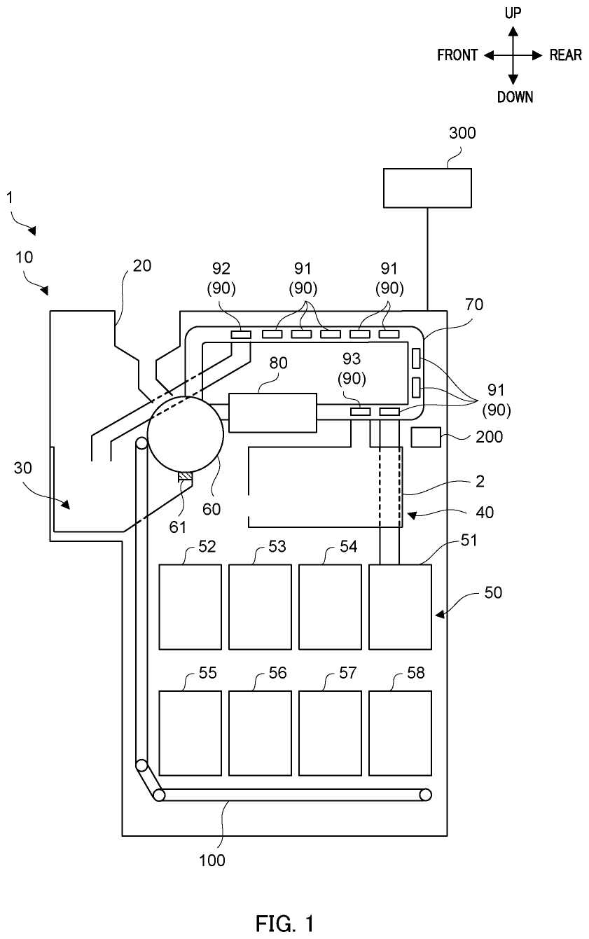

FIG. 1 is a schematic diagram illustrating an example of the configuration of a coin handling apparatus 1 according to the present embodiment. FIG. 1 illustrates an internal configuration of the coin handling apparatus 1 as viewed from the right side. FIG. 1 illustrates a front-rear direction and an up-down direction with respect to the coin handling apparatus 1, and the description will be made based on the directions in the present specification.

The coin handling apparatus 1 is installed in a front office of various facilities comprising a bank or other financial institution's store (finance store) or a convenience store or other store (distribution store). The coin handling apparatus 1 is operated by a store employee or a customer himself/herself in a store, and is used for a settlement process between the store employee and the customer. The coin handling apparatus 1 performs, for example, a deposit process of depositing a payment amount paid by a customer and a dispensing process of paying out change to be paid to the customer. The coin handling apparatus 1 is communicably connected to, for example, a point of sales (POS) register to be operated by a store employee or a register for self-checkout to be operated by a customer. The coin handling apparatus 1 may be configured integrally with the POS register or the register for self-checkout.

As illustrated in FIG. 1, the coin handling apparatus 1 comprises a housing 10, a deposit unit 20, a dispensing unit 30, a cassette mounting unit 40, a storage unit 50 (also referred to as ‘storage’), a feeding unit 60, a deposit transport unit 70, a recognition unit 80 (also referred to as ‘recognition circuitry’), a plurality of chutes 90, a dispensing transport unit 100, and a control unit 200 (also referred to as ‘control circuitry’).

The deposit unit 20 is provided on the front side of an upper surface portion of the housing 10. That is, the deposit unit 20 is provided on the side on which a customer stands when the coin handling apparatus 1 is operated. The deposit unit 20 is configured to allow a coin C to be deposited into the coin handling apparatus 1.

The dispensing unit 30 is provided on the upper side of a front surface portion of the housing 10. The dispensing unit 30 is configured to dispense a coin C from the coin handling apparatus 1.

The cassette 2 that stores coins C is mounted on the cassette mounting unit 40. The cassette mounting unit 40 is covered with a cover (not illustrated) when the cassette 2 is not mounted, and is exposed when the cover is opened. When the cassette 2 is mounted on the cassette mounting unit 40, a connector of the cassette 2 and a connector (not illustrated) of the cassette mounting unit 40 are connected.

An operation display unit 300 is connected to the coin handling apparatus 1. The operation display unit 300 is configured by, for example, a touch panel type display device, and functions as an operation unit for inputting information on the coin processing in the coin handling apparatus 1 and as a display unit for displaying information on the coin processing. The operation display unit 300 may be configured separately from the coin handling apparatus 1 or may be configured integrally with the coin handling apparatus 1. The operation display unit 300 may be configured in such a way that the operation unit and the display unit are provided independently.

The storage unit 50 is a storage configured to store coins. The storage may be a container, a cassette, or a hopper. The storage unit 50 comprises a plurality (eight in this example) of denomination-specific storage units 51, 52, 53, 54, 55, 56, 57, and 58 (hereinafter, referred to as “denomination-specific storage units 51 to 58”).

The denomination-specific storage units 51 to 58 are configured to store coins C or feed out the stored coins C. The denomination-specific storage units 51 to 58 are capable of feeding out a predetermined number of coins C, but are not capable of selectively feeding out coins C of a specific denomination. The denomination-specific storage units 51 to 58 store coins in a bulk state. An example of the mechanism for feeding out coins C from the denomination-specific storage units 51 to 58 is a mechanism that uses a rotating disk and a plurality of protrusion members—the rotating disk is configured to rotate in a tilted state, and the plurality of protrusion members is located in an outer region of the surface of the rotating disk and configured to lift and feed out coins C one by one. With this feeding-out mechanism, the denomination specific storage units 51 to 58 are capable of counting the number of coins C to be fed out. However, since the coins C stored in a bulk state are picked up one by one by the rotating disk and fed out, the denomination-specific storage units 51 to 58 are not capable of selectively feeding out a specific coin. The denomination to be stored in each of the denomination-specific storage units 51 to 58 is set in advance.

In the present embodiment, in at least one of the denomination-specific storage units 51 to 58, a plurality of types of coins C (plurality of denominations) are stored, and in the remaining denomination-specific storage units, one type of coins C (single denomination) is stored. For example, in this example, a plurality of denominations is stored in the denomination-specific storage unit 51, and a single denomination is stored in each of the denomination-specific storage units 52 to 58. Hereinafter, the denomination-specific storage unit 51 may be referred to as a “multiple denomination storage unit 51”, and the denomination-specific storage units 52 to 58 may be referred to as “single denomination storage units 52 to 58”. In the case of the single denomination storage units 52 to 58, both the number of coins C to be fed out and the denomination of the coins C to be fed out are specified. In contrast, in the case of the multiple denomination storage unit 51, the total number of coins C to be fed out is specified, but the number of coins C for each denomination is not specified.

The feeding unit 60 is configured to receive coins C deposited from the deposit unit 20 and to feed out the coins C one by one or to cause the coins C to fall into the dispensing unit 30. An example of a mechanism for feeding out coins C from the feeding unit 60 may be the same mechanism as of the denomination-specific storage units 51 to 58.

The deposit transport unit 70 transports coins C fed out from the feeding unit 60. The deposit transport unit 70 may be a conveyor. Specifically, the deposit transport unit 70 may include a transport path having an inclined surface that guides the coins C, and a belt with pins that transports the coins C while pushing the coins C one by one.

The recognition unit 80 is provided in the deposit transport unit 70. The recognition unit 80 may be an identification circuit including a processor (CPU), a memory, and sensors. The recognition unit 80 acquires information of coins C detected by the sensors and identifies the coins based on the acquired information. The recognition unit 80 may acquire, from the sensors, information based on ultraviolet light, visible light, infrared light, magnetism, thickness of a medium, and the like. The recognition unit 80 recognizes the denomination, authenticity, fitness and the like of the coins C deposited from the deposit unit 20 or the coins C transported via the dispensing transport unit 100, and counts the coins C for each denomination.

The plurality of chutes 90 are provided downstream of the recognition unit 80 located in the deposit transport unit 70 in the transport direction of the coins C. The plurality of chutes 90 are provided in a row in the transport direction of the coins C. Eight chutes 91 among the plurality of chutes 90 are configured to guide a coin C to any one of the denomination-specific storage units 51 to 58. Another one of the chutes 92 is configured to guide a coin C to the dispensing unit 30. The remaining one chute 93 is configured to guide a coin C to the cassette 2 mounted on the cassette mounting unit 40. The chutes 90 are normally closed by a gate (not illustrated), and a coin C is guided to each of the above units by opening the gate.

The dispensing transport unit 100 is provided below the feeding unit 60. The dispensing transport unit 100 transports coins C fed out from the denomination-specific storage units 51 to 58 to the feeding unit 60. The dispensing transport unit 100 transports a coin C that is discharged and falls from the cassette 2 to the feeding unit 60. The dispensing transport unit 100 may be a conveyor. Specifically, the dispensing transport unit 100 may include a belt conveyor that transports a plurality of coins C together.

The cassette 2 is configured to be attachable to and detachable from the coin handling apparatus 1. The cassette 2 is configured to exchange coins C with the coin handling apparatus 1 when the cassette 2 is mounted on the coin handling apparatus 1.

The cassette 2 stores a coin C that is dropped by the deposit transport unit 70 to fall into the chute 93. In addition, the cassette 2 feeds out the stored coins C. The coins C fed out by the cassette 2 fall onto the transport path of the dispensing transport unit 100, as in the case of the coins C fed out from the storage unit 50. The cassette 2 is used for, for example, a collection process for collecting coins C and a replenishment process for replenishing with coins C.

In addition, the cassette 2 also functions as an overflow storage unit that stores overflow coins that cannot be stored for the denomination assigned to each of the multiple denomination storage unit 51 and the single denomination storage units 52 to 58. The cassette 2 corresponds to a “second multiple denomination storage unit” and a “collection cassette” according to the present embodiment.

The control unit 200 controls the operation of the entire coin handling apparatus 1. The control unit 200 controls the deposit process of a coin C to be paid by a customer in the case of the settlement of a product. When controlling the deposit process, for example, the control unit 200 controls the feeding unit 60 and the deposit transport unit 70 in such a way that coins C that are received from the deposit unit 20 and fall to the feeding unit 60 are fed out and transported one by one. The denomination, authenticity, fitness and the like of the coins C to be transported are recognized by the recognition unit 80. The control unit 200 controls the deposit transport unit 70 and the gate based on the recognition result in the recognition unit 80 in such a way that a coin C that cannot be deposited is rejected and discharged to the dispensing unit 30. The control unit 200 controls the deposit transport unit 70 and the chute 90 in such a way that a coin C that can be deposited is stored in the denomination-specific storage units 51 to 58 according to the denomination.

In addition, the control unit 200 controls the dispensing process of a coin C in the case of the settlement of a product. When controlling the dispensing process, for example, the control unit 200 controls the denomination-specific storage units 51 to 58 and the dispensing transport unit 100 in such a way that coins C that are fed out from the denomination-specific storage units 51 to 58 (which store the coins C to be dispensed) and fall are transported to the feeding unit 60 one by one. The control unit 200 controls the feeding unit 60 in such a way that a coin C is discharged to the dispensing unit 30 by opening a bottom portion 61 of the feeding unit 60. Specific details of the dispensing process by the control unit 200 will be described below.

In addition, the control unit 200 performs a replenishment process of replenishing the storage unit 50 with coins C stored in the cassette 2. Further, the control unit 200 performs a transport process of transporting the coins C stored in the storage unit 50 to the cassette 2. The transport process is one embodiment of a collection process. Details of the replenishment process and the transport process will be described below.

### Configuration of Control Unit 200

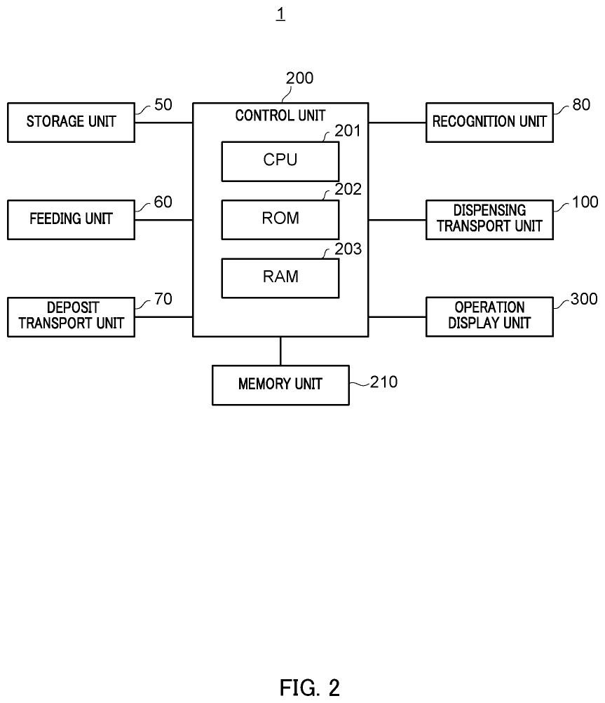

FIG. 2 is a block diagram illustrating an example of a functional block of the coin handling apparatus 1. The control unit 200 is a processor that controls each configuration of the coin handling apparatus 1. Each unit of the coin handling apparatus 1 is connected to the control unit 200, and a memory unit 210 (also referred to as ‘memory’) is connected to the control unit 200. The memory unit 210 is a storage device such as a memory that stores various types of data, programs, and the like necessary for the process executed by the control unit 200. The memory unit 210 is configured by, for example, a non-volatile semiconductor memory (also referred to as flash memory) or a hard disk drive.

The control unit 200 is a control circuitry that comprises a central processing unit (CPU) 201, a read only memory (ROM) 202, a random access memory (RAM) 203, and the like. The CPU 201 reads out a program corresponding to the processing content from the ROM 202, loads the program into the RAM 203, and centrally controls the operations of the blocks of the coin handling apparatus 1 in cooperation with the loaded program.

### Dispensing Process by Coin Handling Apparatus 1

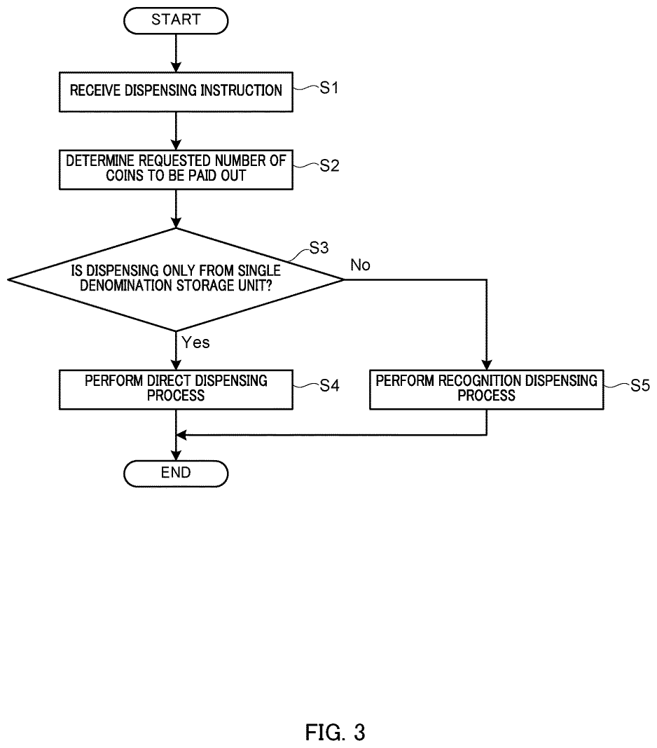

Next, a dispensing process by the coin handling apparatus 1 according to the present embodiment will be described. FIG. 3 is a flowchart illustrating an example of a flow of the dispensing process by the coin handling apparatus 1 according to the present embodiment.

In step S1, the control unit 200 receives a dispensing instruction from the operation display unit 300 connected to the coin handling apparatus 1. The control unit 200 may receive the dispensing instruction from a higher-level terminal (not illustrated) or the like connected to the coin handling apparatus 1. In step S2, the control unit 200 determines a requested number of coins to be paid out for each denomination based on the received dispensing instruction. Here, the dispensing instruction comprises, for example, the requested number of coins to be paid out for each denomination corresponding to the amount to be paid out. In addition, the present embodiment is not limited to this, and, for example, the dispensing instruction may comprise the amount to be paid out. When the dispensing instruction comprises the amount to be paid out, the control unit 200 determines the requested number of coins to be paid out for each denomination based on the amount to be paid out comprised in the received dispensing instruction.

When the control unit 200 determines the requested number of coins to be paid out for each denomination, in step S3, the control unit 200 determines whether or not the coins C are paid out only from the single denomination storage units 52 to 58 based on the requested number. When the determination result is that the coins C are paid out only from the single denomination storage units 52 to 58 (step S3: Yes), in step S4, the control unit 200 executes a direct dispensing process. The direct dispensing process is a dispensing process of performing a feeding out process of feeding out coins C from the single denomination storage units 52 to 58 and directly discharging the coins C fed out by the feeding out process to the dispensing unit 30.

### Direct Dispensing Process

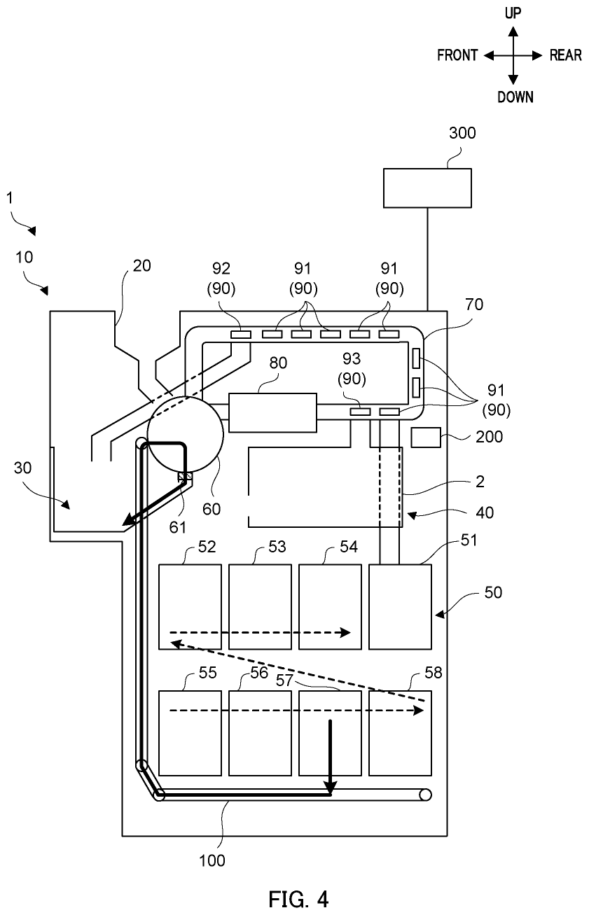

FIG. 4 is a schematic diagram for describing the direct dispensing process. As illustrated in FIG. 4, in the direct dispensing process, the control unit 200 controls the storage unit 50 in such a way that coins C are fed out from the single denomination storage units 52 to 58 by the number of coins as needed based on the requested number. The single denomination storage units 52 to 58 of the storage unit 50 feed out the coins C to be dispensed under the control of the control unit 200. As a result, the coins C fall onto the transport path of the dispensing transport unit 100.

When coins C are fed out from the plurality of single denomination storage units 52 to 58, for example, the coins C are sequentially fed out in a predetermined order shown by a broken line in FIG. 4. In addition, the order in which the coins C are fed out is not limited to this example as long as the coins C are fed out in a predetermined order.

The dispensing transport unit 100 sequentially transports the coins C having fallen onto the transport path to the feeding unit 60. At this time, the bottom portion 61 of the feeding unit 60 is open. Therefore, the coins C having fallen into the feeding unit 60 are discharged to the dispensing unit 30 without being stored in the feeding unit 60.

As described above, in the direct dispensing process, the coins C are fed out only from the single denomination storage units 52 to 58 each storing a single denomination determined in advance, so that it is not necessary to recognize the denomination. Therefore, in the direct dispensing process, the coins C are directly dispensed from the dispensing unit 30 without being recognized by the recognition unit 80.

On the other hand, in step S3 of FIG. 3, when coins C are paid out not only from the single denomination storage units 52 to 58, that is, when the coins C are also paid out from the multiple denomination storage unit 51 (step S3: No), the control unit 200 executes a recognition dispensing process in step S5. The recognition dispensing process is a dispensing process of performing a feeding out process to feed out both coins C fed out from the single denomination storage units 52 to 58 and coins C fed out from the multiple denomination storage unit 51, and discharging the coins C fed out by the feeding out process to the dispensing unit 30 after recognizing the coins C.

### Recognition Dispensing Process

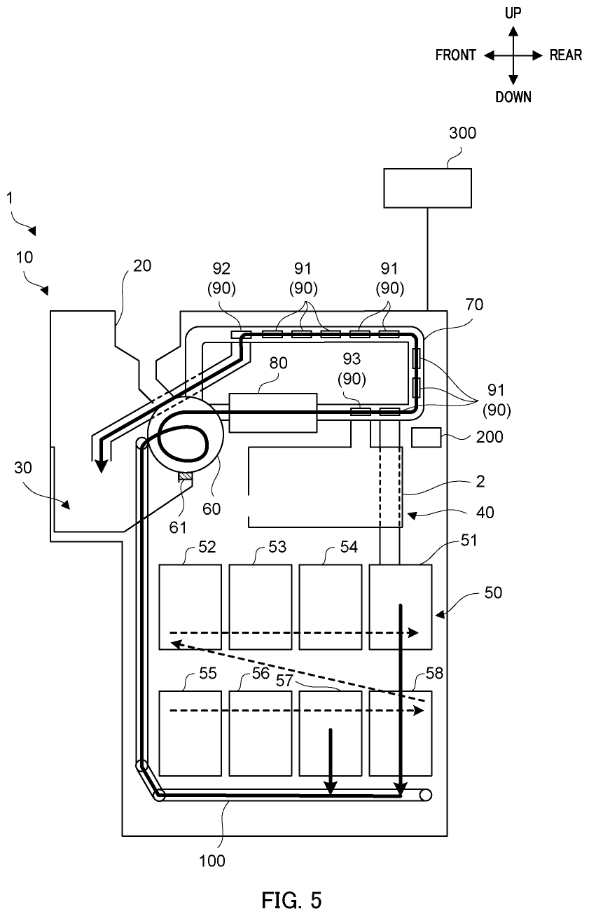

FIG. 5 is a schematic diagram for describing a recognition dispensing process. As illustrated in FIG. 5, in the recognition dispensing process, the control unit 200 controls the storage unit 50 in such a way that coins C are fed out from the single denomination storage units 52 to 58 by the number of coins as needed and a coin C is also fed out from the multiple denomination storage unit 51.

The single denomination storage units 52 to 58 of the storage unit 50 feed out the coins C to be dispensed under the control of the control unit 200. As a result, the coins C fed out from the single denomination storage units 52 to 58 fall onto the transport path of the dispensing transport unit 100.

In addition, the multiple denomination storage unit 51 feeds out the coins C under the control of the control unit 200. As a result, the coins C fed out from the multiple denomination storage unit 51 fall onto the transport path of the dispensing transport unit 100.

When coins C are fed out from the multiple denomination storage unit 51 and the plurality of single denomination storage units 52 to 58, for example, the coins C are sequentially fed out in a predetermined order shown by a broken line in FIG. 5. In addition, the order in which the coins C are fed out is not limited to this example as long as the coins C are fed out in a predetermined order.

Next, the dispensing transport unit 100 sequentially transports the coins C having fallen onto the transport path to the feeding unit 60. At this time, the bottom portion 61 of the feeding unit 60 is closed. Therefore, the coins C having fallen into the feeding unit 60 are fed out to the transport path of the deposit transport unit 70 without being discharged to the dispensing unit 30.

The deposit transport unit 70 transports the coins C having been fed out to the transport path in such a way that the coins pass through the recognition unit 80. The recognition unit 80 recognizes the denomination, authenticity, fitness and the like of the coins C passing therethrough, and counts the coins C for each denomination. As a result of the recognition by the recognition unit 80, a coin C corresponding to the requested number of coins to be paid out is discharged from the chute 92 to the dispensing unit 30. In addition, a coin C that is fed out from the multiple denomination storage unit 51 but is no longer needed is discharged from the chute 91 to the multiple denomination storage unit 51.

As described above, in the recognition dispensing process, all the coins C comprising coins C fed out from the multiple denomination storage unit 51 are recognized. As a result, among the transported coins C, only a coin C corresponding to the requested number of coins to be paid out is discharged to the dispensing unit 30. In addition, the remaining coins C are discharged to the multiple denomination storage unit 51. In the dispensing process, when coins C are fed out from at least one of the single denomination storage units 52 to 58 and the multiple denomination storage unit 51, the coins C fed out from the single denomination storage units 52 to 58 may be dispensed by a direct dispensing process, and the coins C fed out from the multiple denomination storage unit 51 may be dispensed by a recognition dispensing process. In this case, it is necessary to perform the recognition dispensing process after completion of the direct dispensing process and after no coins C remain on the transport path, which increases the time required for the dispensing process. In the above-described example, since both the coins C fed out from the single denomination storage units 52 to 58 and the coins C fed out from the multiple denomination storage unit 51 are dispensed by the recognition dispensing process, there is no problem even if these coins C are mixed on the transport path. Coins C may be fed out simultaneously from the single denomination storage units 52 to 58 and the multiple denomination storage unit 51. At least a part of the coins C fed out from the single denomination storage units 52 to 58 and at least a part of the coins C fed out from the multiple denomination storage unit 51 may be present on the transport path at the same time. As a result, the time required for the dispensing process can be reduced.

### Determination of Number of Coins C to be Fed Out From Multiple Denomination Storage Unit 51

Here, the number of coins C to be fed out from the multiple denomination storage unit 51 will be described. The multiple denomination storage unit 51 stores a plurality of types of coins C in a random order. Therefore, at the time when a coin C is fed out from the multiple denomination storage unit 51, it is not possible to determine which type of coin is fed out from the multiple denomination storage unit 51. Therefore, the control unit 200 controls the multiple denomination storage unit 51 to feed out coins C by the number more than the requested number of coins C to be fed out. This is because the probability that a necessary coin C is fed out from the multiple denomination storage unit 51 is increased by feeding out a large number of coins C.

Meanwhile, in the case of feeding out coins C from the multiple denomination storage unit 51, when the number of coins C to be fed out is larger than necessary, the time required for the recognition dispensing process increases, and the dispensing efficiency deteriorates. On the other hand, when the number of coins C to be fed out from the multiple denomination storage unit 51 is small, there is a possibility that the requested type of coins C are not fed out.

Therefore, in the present embodiment, coins C are fed out from the multiple denomination storage unit 51 by the number that would ensure that at least one requested denomination of coin C is fed out with a predetermined probability (for example, 99% or more) among the plurality of types of coins C stored in the multiple denomination storage unit 51.

For example, when the plurality of types of coins C stored in the multiple denomination storage unit 51 are in equal proportions, the number Y of coins necessary to be fed out for feeding out the necessary number of coins C of the requested denomination with a probability of 99% or more is determined based on the following equation (1). In the equation (1), the “instructed number of coins of maximum instructed denomination” is the number of coins of a denomination having the maximum requested number among the denominations requested by the dispensing instruction with respect to the denominations stored in the multiple denomination storage unit 51.

$$Y = ( instructed number of coins of a maximum instructed denomination + 1 ) \times 5 \qquad ( 1 )$$

On a basis of the requested number of coins to be paid out, the control unit 200 calculates and determines the number of coins C to be fed out from the multiple denomination storage unit 51 based on the equation (1) described above.

The determination of the number of coins C to be fed out from the multiple denomination storage unit 51 is not limited to this example. For example, the memory unit 210 stores a table in which a denomination having the maximum requested number among the denominations stored in the multiple denomination storage unit 51 is associated with the number of coins C to be fed out from the multiple denomination storage unit 51 in advance. Then, the control unit 200 may determine the number of coins C to be fed out from the multiple denomination storage unit 51 based on the table stored in the memory unit 210.

### Ratio of Coins C Stored in Multiple Denomination Storage Unit 51

In order to appropriately feed out the necessary coins C from the multiple denomination storage unit 51, it is necessary that the ratio of each of the plurality of types of coins C (hereinafter, appropriately referred to as “each denomination (or respective denominations when referring to a plurality of denominations)”) in the multiple denomination storage unit 51 is within a predetermined range. Specifically, the predetermined range is a range in which the proportions of respective denominations in the multiple denomination storage unit 51 are equal.

For example, when two types of coins C are stored in the multiple denomination storage unit 51, the ratio of each of the coins C needs to be within a range of 40:60 to 60:40. In a case where three or more types of coins C are stored in the multiple denomination storage unit 51, a ratio between numbers of coins C of any two types of the coins C needs to fall within a range of 40:60 to 60:40. In the following description, the term “equal” for the proportions when two types of coins C are stored in the multiple denomination storage unit 51 means that each ratio is “within a range of 40:60 to 60:40”.

On the other hand, when the coins C are repeatedly fed out, the proportion of each denomination in the multiple denomination storage unit 51 changes and deviates from the predetermined range. Therefore, in the present embodiment, when the proportions of respective denominations in the multiple denomination storage unit 51 fall outside the predetermined range, processing is performed in such a way that the proportions become equal.

Hereinafter, using first to third examples, the following processing will be described: processing for adjusting the quantity of coins C in the multiple denomination storage unit 51 in such a way that when the proportions of denominations in the multiple denomination storage unit 51 are outside the predetermined range, each proportion is adjusted to fall within the predetermined range.

### First Example

The first example is such that the proportions of the plurality of types of coins C in the multiple denomination storage unit 51 fall within the predetermined range by prioritizing the feeding out of the coins C whose quantity is larger than the appropriate quantity among the plurality of types of coins C. The appropriate quantity is a quantity such as an appropriate quantity of stored coins C of each denomination stored in the multiple denomination storage unit 51 or an appropriate proportion (ratio) of each denomination stored in the multiple denomination storage unit 51.

For example, the control unit 200 compares the quantity of the coins (herein also “coin quantity”) of each denomination in the multiple denomination storage unit 51 with the appropriate quantity. In this case, the memory unit 210 stores in advance the coin quantity of each denomination stored in the multiple denomination storage unit 51 and the appropriate quantity corresponding to each denomination. The control unit 200 specifies the denomination having a coin quantity larger than the appropriate quantity based on the comparison result. Then, the control unit 200 controls the storage unit 50 in such a way that the feeding out of the coins C of the specified denomination is prioritized in the dispensing process.

As described above, the ratio between the denominations in the multiple denomination storage unit 51 changes by feeding out the coins C of the denomination having a coin quantity larger than the appropriate quantity. Therefore, the proportion of each denomination in the multiple denomination storage unit 51 can be brought close to the predetermined range.

The first example describes a configuration such that coins C of a denomination having a coin quantity larger than the appropriate quantity are fed out, but the present embodiment is not limited to this. Alternatively, for coins C of a denomination having a coin quantity smaller than the appropriate quantity, other coins C that can be used as a substitute may be fed out. As a result, the feeding out of the coins C of the denomination having a coin quantity smaller than the appropriate quantity is suppressed, so that the proportions of the plurality of types of coins C in the multiple denomination storage unit 51 can be adjusted to fall within the predetermined range.

### Second Example

The second example ensures that the proportions of the plurality of types of coins C in the multiple denomination storage unit 51 fall within the predetermined range by performing a transport process that stores coins C whose quantity is in excess of the appropriate quantity (among the plurality of types of coins C in the multiple denomination storage unit 51) in a second multiple denomination storage unit, which is different from the storage unit 50. This transport process can also be regarded as a collection process for collecting the coins C in the multiple denomination storage unit 51 into the second multiple denomination storage unit.

The second multiple denomination storage unit is a storage unit that can store the plurality of types of coins C and is different from the storage unit 50. In the present embodiment, the second multiple denomination storage unit is, for example, the cassette 2. For example, when the coin handling apparatus 1 is initially replenished before the store is opened, the cassette 2 does not store any coin C. Therefore, in the present embodiment, the cassette 2 in which no coins C are stored is used as the second multiple denomination storage unit for adjusting the proportions of the denominations in the multiple denomination storage unit 51.

For example, in the transport process, the control unit 200 compares the coin quantity of each denomination in the multiple denomination storage unit 51 with the appropriate quantity and calculates a difference for each denomination. The control unit 200 transports coins C of each denomination corresponding to each calculated difference to the cassette 2 serving as the second multiple denomination storage unit.

As described above, coins C are transported to the cassette 2 serving as the second multiple denomination storage unit by the quantity corresponding to the difference between the coin quantity of each denomination in the multiple denomination storage unit 51 and the appropriate quantity. In such a manner, the coin quantity of each denomination in the multiple denomination storage unit 51 becomes the appropriate quantity, and the ratio between the denominations changes. Therefore, the proportion of each denomination in the multiple denomination storage unit 51 can be brought close to the predetermined range.

The transport process is performed, for example, when the deposit process or the dispensing process is performed. In addition, the present embodiment is not limited to this, and, for example, the transport process may be performed when the coin handling apparatus 1 is not operating.

### Third Example

The third example ensures that the proportions of the plurality of types of coins C in the multiple denomination storage unit 51 fall within the predetermined range by performing a replenishment process that replenishes coins C whose quantity is smaller than the appropriate quantity (among the plurality of types of coins C in the multiple denomination storage unit 51) from the second multiple denomination storage unit.

For example, in the replenishment process, the control unit 200 compares the coin quantity of each denomination in the multiple denomination storage unit 51 with the appropriate quantity and checks whether or not there is a denomination having a coin quantity smaller than the appropriate quantity. As a result of the check, when there is a denomination having a coin quantity smaller than the appropriate quantity, the control unit 200 transports and replenishes the coins C of this denomination from the cassette 2 serving as the second multiple denomination storage unit to the multiple denomination storage unit 51.

As described above, the ratio between the denominations in the multiple denomination storage unit 51 changes by replenishing the coins C of the denomination having a coin quantity smaller than the appropriate quantity from the second multiple denomination storage unit. Therefore, the proportion of each denomination in the multiple denomination storage unit 51 can be brought close to the predetermined range.

### Empty Feeding Out Process

In the recognition dispensing process, among the plurality of denominations fed out from the multiple denomination storage unit 51, a denomination that is not a target for the payout and the like is returned to the multiple denomination storage unit 51. Therefore, in the case of feeding out the desired denomination from the multiple denomination storage unit 51 after that, the probability that this denomination is fed out is reduced, and it may be difficult to appropriately feed out the desired denomination. Therefore, in this case, an empty feeding out process of feeding out all the denominations stored in the multiple denomination storage unit 51 may be performed.

In the empty feeding out process, the multiple denomination storage unit 51 feeds out all the coins C in the multiple denomination storage unit 51 under the control of the control unit 200 and causes the coins C to fall onto the transport path of the dispensing transport unit 100. At this time, the dispensing transport unit 100 does not start transporting the coins C having fallen onto the transport path until all the coins C in the multiple denomination storage unit 51 are fed out.

When all the coins C in the multiple denomination storage unit 51 fall onto the transport path of the dispensing transport unit 100, the dispensing transport unit 100 sequentially transports the coins C having fallen to the transport path to the feeding unit 60. Then, the coin handling apparatus 1 performs the recognition by the recognition unit 80 on all the coins C as in the recognition dispensing process, and discharges a coin C corresponding to the requested number of coins to be paid out to the dispensing unit 30 and discharges a coin C that is no longer needed to the multiple denomination storage unit 51.

Since all the coins C in the multiple denomination storage unit 51 are fed out in the empty feeding out process, it takes time to discharge all the coins C located on the transport path to the dispensing unit 30 or to the multiple denomination storage unit 51. Therefore, it is preferable that the condition for executing the empty feeding out process is set by the user.

For example, the empty feeding out process may be performed in accordance with the number of coins C and the ratio between the plurality of denominations in the multiple denomination storage unit 51. More specifically, the empty feeding out process may be performed when the inventory amount in the multiple denomination storage unit 51 is, for example, a predetermined quantity or less, such as the case where the inventory amount in the multiple denomination storage unit 51 satisfies “inventory amount in multiple denomination storage unit 51 <number of coins to be fed out for requested number of coins to be paid out×2”. In addition, for example, the empty feeding out process may be performed when a predetermined or more bias occurs in the ratio between the denominations in the multiple denomination storage unit 51.

Further, the empty feeding out process may be performed before the payout process is started, or may be performed when the payout time or the number of retries of the feeding out exceeds a predetermined value. In addition, when the empty feeding out process is performed, the reconciliation process of the multiple denomination storage unit 51 can also be executed at the same time as the payout process.

As described above, in the empty feeding out process, even when the inventory amount for the denominations stored in the multiple denomination storage unit 51 is a predetermined amount or less or when a predetermined value or more bias occurs in the configuration ratio between the inventory amounts, coins C corresponding to the requested number of coins to be paid out can be appropriately discharged to the dispensing unit 30.

As described above, in the coin handling apparatus 1 according to the present embodiment, the control unit 200 determines the number of coins to be fed out from the multiple denomination storage unit 51 based on the requested numbers for the plurality of denominations of coins stored in the multiple denomination storage unit 51. Then, the control unit 200 performs a feeding out process of feeding out coins by the number of coins to be fed out from the multiple denomination storage unit 51.

As a result, coins of a desired denomination corresponding to the requested number of coins to be paid out are fed out from the multiple denomination storage unit 51. Therefore, even when the plurality of types of coins are stored in the multiple denomination storage unit 51, coins can be appropriately fed out from the multiple denomination storage unit 51.

Although the embodiment has been described above, the present technology is not limited to the above-described embodiment, and various modifications and applications can be made without departing from the spirit of the present technology. For example, a shutter that is opened in the case of the deposit process and closed in the case of the dispensing process may be disposed in the deposit unit 20. By disposing the shutter in the deposit unit 20, it is possible to prevent the user from mistakenly inserting a coin C in the case of the dispensing process.

### REFERENCE SIGNS LIST

1 Coin handling apparatus
2 Cassette
10 Housing
20 Deposit unit
30 Dispensing unit
40 Cassette mounting unit
50 Storage unit
51, 52, 53, 54, 55, 56, 57, 58 Denomination-specific storage unit
60 Feeding unit
61 Bottom portion
70 Deposit transport unit
80 Recognition unit
90 Chute
91, 92, 93 Chute
100 Dispensing transport unit
200 Control unit
201 CPU
202 ROM
203 RAM
210 Memory unit
300 Operation display unit

1. A coin handling apparatus that pays out a coin corresponding to a requested number of coins to be paid out based on a dispensing instruction, the coin handling apparatus comprising:
a multiple denomination storage that stores coins of a plurality of denominations; and
a control circuitry that, in a case where it is necessary to pay out a coin of at least one denomination among the plurality of denominations stored in the multiple denomination storage, determines the number of coins to be fed out from the multiple denomination storage based on the requested number and performs a feeding out process of feeding out the coins by the determined number from the multiple denomination storage.

2. The coin handling apparatus according to claim 1, wherein
the control circuitry determines the number of coins to be fed out in such a way that all of the requested number of coins to be paid out is fed out from the multiple denomination storage with a probability of a predetermined value or more.

3. The coin handling apparatus according to claim 1, further comprising:
a memory that stores an appropriate quantity for each of the plurality of denominations in the multiple denomination storage, wherein
the control circuitry adjusts a coin quantity of each denomination in the multiple denomination storage based on a difference obtained by comparing the coin quantity of each denomination in the multiple denomination storage with the appropriate quantity.

4. The coin handling apparatus according to claim 3, wherein
the control circuitry controls the multiple denomination storage in such a way that a coin of a denomination in the multiple denomination storage is paid out, the denomination having a coin quantity larger than the appropriate quantity.

5. The coin handling apparatus according to claim 3, further comprising:
a second multiple denomination storage that stores coins of a plurality of denominations, wherein
the control circuitry adjusts the coin quantity of each denomination in the multiple denomination storage by moving a coin between the multiple denomination storage and the second multiple denomination storage, based on a difference obtained by comparing the coin quantity of each denomination in the multiple denomination storage with the appropriate quantity.

6. The coin handling apparatus according to claim 5, wherein
the control circuitry performs a transport process of transporting a coin to the second multiple denomination storage, the transported coin corresponding to a difference obtained by comparing the coin quantity of each of the plurality of denominations in the multiple denomination storage with the appropriate quantity.

7. The coin handling apparatus according to claim 6, wherein
the control circuitry performs the transport process when a deposit process or a dispensing process is performed.

8. The coin handling apparatus according to claim 5, wherein:
the control circuitry compares the coin quantity of each of the plurality of denominations in the multiple denomination storage with the appropriate quantity; and
the control circuitry performs a replenishment process of replenishing the multiple denomination storage with a coin of a denomination having a coin quantity smaller than the appropriate quantity from the second multiple denomination storage.

9. The coin handling apparatus according to claim 5, further comprising:
a recognition circuitry that recognizes a denomination of a coin contained in the coin handling apparatus, wherein
the control circuitry, in the transport process, transports the coin fed out from the multiple denomination storage to the second multiple denomination storage after recognizing the denomination of the coin by using the recognition circuitry.

10. The coin handling apparatus according to claim 3, wherein
the appropriate quantity is a coin quantity having a ratio within a range of 40:60 to 60:40, the ratio being a ratio of the coin quantity between any two denominations among the denominations stored in the multiple denomination storage.

11. The coin handling apparatus according to claim 1, further comprising:
a recognition circuitry that recognizes a denomination of a coin contained in the coin handling apparatus, wherein
the control circuitry recognizes, by using the recognition circuitry, the denomination of the coin fed out from the multiple denomination storage by executing the feeding out process.

12. The coin handling apparatus according to claim 11, further comprising:
a single denomination storage that stores a coin of one denomination, wherein the control circuitry is configured:
in a case where it is determined, based on the requested number of coins, that a coin is to be fed out only from the single denomination storage, not to cause the denomination of the coin fed out from the single denomination storage to be recognized by the recognition circuitry;
in a case where it is determined, based on the requested number of coins, that a coin is to be fed out from both the single denomination storage and the multiple denomination storage, to cause the denomination of the coin fed out from the single denomination storage to be recognized by the recognition circuitry.
